(19) United States
(12) Patent Application Publication
(10) Pub. No.: US 2002/0194110 A1
(43) Pub. Date: Dec. 19, 2002

(54) Methods and systems for implementing a forward conversion securities strategy

(76) Inventor: Shayne Young, Austin, TX (US)

Correspondence Address: Eric B. Meyertons, CONLEY, ROSE & TAYON, P.C., P.O. Box 398, Austin, TX, 78767-0398, US

(21) Appl. No.: 09/885,817

(22) Filed: Jun. 19, 2001

(51) Int. Cl. G06F 17/60

(52) U.S. Cl. 705/37; 705/36

(57) ABSTRACT

Methods and systems for implementing a forward conversion strategy are provided. In one embodiment, the invention may provide a computer-implemented method for implementing a forward conversion strategy. The method may include receiving securities orders for at least one security. The received securities orders may include a long stock order, a long put order, and a short call order. The received securities orders may be automatically transferred from a first entity to a second entity or from the first entity to one or more intermediate entities and then to the second entity for execution of the securities orders. Portions of the securities orders may be verified. Upon execution of the securities orders, the securities orders may be automatically updated with execution completion information. The execution completion information may be automatically displaying on a computer system, upon execution of the securities orders. The updated securities orders may be transmitted to one or more post-execution entities (e.g., a clearing firm).

### BACKGROUND OF THE INVENTION

1. Field of the Invention

The present invention generally relates to computer software. Certain embodiments relate to a computer-implemented method for collecting information to implement a forward conversion securities strategy.

2. Description of the Related Art

The securities trading industry has burgeoned since the advent of the Internet. Many companies offer securities trading services through a variety of automated systems/methods such as a telephone system or a computer system. The placement of orders to buy or sell securities may be done through the use of an order entry screen on a computer system. Before placing an order, a trader of securities may review technical analysis data and/or quotes which may aid in making trading decisions. As used herein, a “security” is an investment instrument, issued by a corporation, government, or other organization which offers evidence of debt or equity (e.g., stocks, options contracts, futures, bonds, mutual funds, and other investments). As used herein, “technical analysis” is a method for evaluating securities by relying on the assumption that market data (e.g., charts of price, volume, and open interest) may help predict future (usually relatively short-term) market trends. As used herein, an “order” is an offer to buy a specified quantity of a particular security or an offer to sell a specified quantity of a particular security.

A trader may place a series of “orders” as a unit of work (i.e., if all orders in the series cannot be filled, then none of the orders in the series are filled). For example, a “conversion” unit of work, as used herein, may refer to a series of orders which may include the following: a long stock position at a user-specified price (i.e., a limit order), a long put position at a user-specified price, and a short call position at a user-specified price. All three positions may be for the same underlying security and for the same number of shares. In addition, the options (i.e., the long put position and the short call position) may share the same strike price, options exchange, and expiration month. The term “conversion strategy” is synonymous with the term conversion unit of work. Also, the term “forward conversion strategy” is synonymous with the term conversion strategy. Similarly, the term “forward conversion securities strategy” is also synonymous with the term conversion strategy. A trader may implement a forward conversion strategy for hedge purposes. As used herein, a “hedge” is a securities transaction in an offsetting position in a related security (e.g., an option). The “hedge” investment is made in an effort to reduce the risk of adverse price movements in a security. As used herein, “risk” is the quantifiable likelihood of loss or less-than-expected returns.

As used herein, a “limit order” is an order to buy a specified quantity of a security at or below a specified price, or to sell the security at or above a specified price. As used herein, a “limit price” is the price specified in a limit order. As used herein, a “position” is an amount of a security either: (1) owned or bought (i.e., a long position) or (2) owed or sold (i.e., a short position) by a trader. As used herein, a “long put position” is an option contract that gives the owner of the option contract a right, but not an obligation, to sell an underlying security (i.e., exercise the option) at a specified price for a certain, fixed period of time (i.e., before a certain date). As used herein, a “short call position” is an option contract that gives the seller of the option contract (also referred to as the option writer) an obligation to sell an underlying security at a specified price for a certain, fixed period of time (i.e., before a certain date). As used herein, a “strike price” is a stated price per share for which the underlying security may be purchased (in the case of a call) or sold (in the case of a put) by the option holder upon exercise of the option contract. As used herein, an “expiration date” for an option is the Saturday following the third Friday of a month. As used herein, an “expiration month” for an option is the month in which the expiration date occurs. An expiration month may also be referred to as a “put/call month.” After an option's expiration date passes, the option will cease to exist (i.e., the option is worthless). As used herein, an “underlying security” is a security subject to being purchased or sold upon exercise of the option contract. When a trader sells a call option while owning the underlying security, the call may be referred to as a “covered call” option. In this case, if the price of the underlying security goes up, past the call strike price, and the buyer of the call option exercises their option, then the trader is obligated to deliver the stock. As used herein, an “options exchange” is any organization, association, or group which provides or maintains a marketplace in which options may be traded (e.g., the Philadelphia Stock Exchange, the Philly or the Chicago Board Options Exchange).

Currently, in order to implement a forward conversion strategy a trader may be required to place three separate orders (i.e., one order for each of the three positions including: a long stock position, a long put position, and a short call position). Due to the complexity of a forward conversion strategy requiring all three separate orders to be filled or none of them to be filled, implementation of a forward conversion strategy is typically a substantially manual process. The three separate orders typically are written on paper by a trader and transmitted to multiple people prior to the orders ultimately being filled. The orders are often transferred verbally. For example, the following steps may be followed to implement a forward conversion strategy: (1) a trader may write three separate order slips or tickets; (2) the trader may hand-deliver or verbally deliver (e.g., via a telephone conversation) the three separate tickets to a broker; (3) the broker may then verbally deliver the three separate tickets to a dealer on the floor of an exchange; and (4) the dealer may then line up the orders, filling them only when it is clear that all three orders may be filled. Due to the human intervention at multiple points in this process for implementing a forward conversion strategy, the process may be prone to time delays and the possibility of errors.

To make implementation of a forward conversion strategy more efficient in the time-critical world of day-trading, it is desirable to provide a system and a method for collecting information which may be necessary to implement the forward conversion strategy in real-time. It is also desirable to decrease the time necessary to complete the implementation process for a forward conversion strategy and to reduce the possibility for error. As used herein, “real-time” indicates a response to stimuli within some relatively small upper limit of response time (e.g., seconds or minutes). Moreover, it is also desirable to provide a system and a method for allowing a trader of securities to customize a display of entry fields which may be used for entering the information necessary to implement the forward conversion strategy in real-time.

Once a trader implements a forward conversion strategy within an account (i.e., establishing three positions in the same underlying security including: a long stock position, a long put position, and a short call position), the trader may desire to monitor the value of the conversion over time. As described above, forward conversion strategies are complex (i.e., all three positions are required to be present in an account in order to maintain the integrity of the conversion). The integrity of the conversion is compromised if any one or more of the three positions are found to be missing within the account. Therefore, it is desirable to monitor the positions, as well as the value, of the conversion over time. It is also desirable to alert the trader when any one or more of the three positions of a particular conversion are found to be missing within the account, thus allowing the trader to manually or automatically restore the conversion by reestablishing the missing position(s).

To make monitoring of positions and values of conversions over time more efficient in the time-critical world of day-trading, it is desirable to provide a system and a method for presenting information regarding conversions within an account in real-time. Moreover, it is also desirable to provide a system and a method for allowing a trader of securities to customize a display of information regarding conversions within an account in real-time.

### SUMMARY OF THE INVENTION

The present disclosure provides various embodiments of improved methods and systems for collecting information necessary to implement a forward conversion strategy. In one embodiment, the invention may provide a trader of securities a computer-implemented method for implementing a forward conversion strategy. The method may include receiving securities orders for at least one security. The received securities orders may include a long stock order, a long put order, and a short call order.

The long stock order may include the following: a long stock symbol, a long stock price, and a long stock quantity. The long put order may include the following: an option symbol, an expiration month, an options exchange, a number of contracts, a strike price, and a long put buy price. The short call order may include the following: an option symbol, an expiration month, an options exchange, a number of contracts, a strike price, a short call sell price.

The received securities orders may be automatically transferred (in real-time or within a specified number of minutes of receiving the securities orders) from a first entity to a second entity for execution of the securities orders. Alternatively, the received securities orders may be automatically transferred from the first entity to one or more intermediate entities and then to the second entity for execution of the securities orders. The securities orders may be transferred without requiring verbal interaction. It is believed that reducing or eliminating verbal interaction in transferring the securities orders may increase the accuracy of order transmission and/or execution. The first and/or second computer may verify certain aspects of the orders to further ensure the accuracy of the orders. The first entity may represent a trader. The one or more intermediate entities may represent a broker. The second entity may represent a dealer on a floor of an exchange (a stock exchange or an options exchange).

The received securities orders may be stored in a memory coupled to a first computer system or in a memory coupled to a second computer system. The second computer system may be coupled to the first computer system over a computer network (e.g., the Internet).

Upon execution of the securities orders, the securities orders may be automatically updated (in real-time or within a specified number of minutes of execution of the securities orders) with execution completion information for the securities orders. Execution completion information may include an execution time and a conversion commission. The execution completion information may include separate execution times and commissions for each leg of the conversion (i.e., the long stock order, the long put order, and the short call order). The execution completion information may be automatically displaying on a computer system, upon execution of the securities orders. The second entity may automatically update the securities orders. The updated securities orders may be transmitted to one or more post-execution entities (e.g., a clearing firm).

### BRIEF DESCRIPTION OF THE DRAWINGS

FIG. 1 is a network diagram of a wide area network suitable for implementing various embodiments;

FIG. 2 is an illustration of a typical computer system suitable for implementing various embodiments;

FIG. 3 is a screenshot of a Forward Conversion Ticket according to one embodiment;

FIG. 4 is a screenshot of a first example using the Forward Conversion Ticket of FIG. 3, according to one embodiment;

FIG. 5 is a screenshot of a second example using the Forward Conversion Ticket of FIG. 3, according to one embodiment;

FIG. 6 is a screenshot of a Conversion Report according to one embodiment; and

FIG. 7 is a flowchart illustrating a method for collecting information necessary to implement a forward conversion strategy in real-time according to one embodiment;

While the invention is susceptible to various modifications and alternative forms, specific embodiments thereof are shown by way of example in the drawings and will be described in detail herein. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

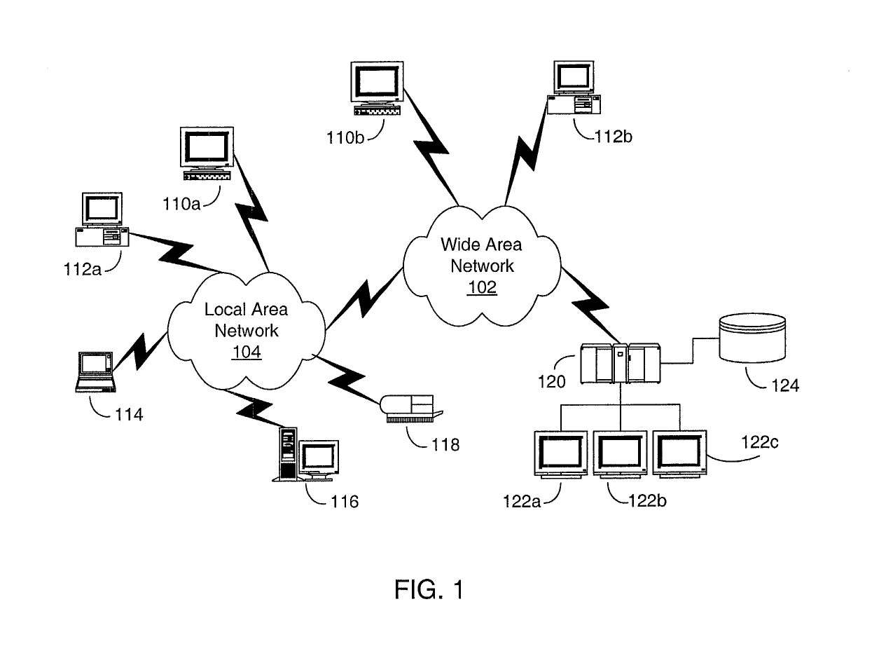

FIG. 1: Wide Area Network

FIG. 1 illustrates a wide area network (WAN) according to one embodiment. WAN 102 is a network that spans a relatively large geographical area. The Internet is an example of WAN 102. WAN 102 typically includes a plurality of computer systems which are interconnected through one or more networks. Although one particular configuration is shown in FIG. 1, WAN 102 may include a variety of heterogeneous computer systems and networks which are interconnected in a variety of ways and which may run a variety of software applications.

One or more local area networks (LANs) 104 may be coupled to WAN 102. A LAN 104 is a network that spans a relatively small area. Typically, a LAN 104 is confined to a single building or a group of buildings. Each node (i.e., individual computer system or device) on a LAN 104 preferably has its own CPU with which it executes programs, and each node is also able to access data and devices anywhere on the LAN 104. The LAN 104 thus allows many users to share devices (e.g., printers) as well as data stored on file servers. The LAN 104 may be characterized by any of a variety of types of topology (i.e., the geometric arrangement of devices on the network), of protocols (i.e., the rules and encoding specifications for sending data, and whether the network uses a peer-to-peer or client/server architecture), and of media (e.g., twisted-pair wire, coaxial cables, fiber optic cables, radio waves).

Each LAN 104 includes a plurality of interconnected computer systems and optionally one or more other devices: for example, one or more workstations 110a, one or more personal computers 112a, one or more laptop or notebook computer systems 114, one or more server computer systems 116, and one or more network printers 118. As illustrated in FIG. 1, an example LAN 104 may include one of each of computer systems 110a, 112a, 114, and 116, and one printer 118. The LAN 104 may be coupled to other computer systems and/or other devices and/or other LANs 104 through WAN 102.

One or more mainframe computer systems 120 may be coupled to WAN 102. As shown, the mainframe 120 may be coupled to a storage device or file server 124 and mainframe terminals 122a, 122b, and 122c. The mainframe terminals 122a, 122b, and 122c may access data stored in the storage device or file server 124 coupled to or included in the mainframe computer system 120.

WAN 102 may also include computer systems which are connected to WAN 102 individually and not through a LAN 104: as illustrated, for purposes of example, a workstation 110b and a personal computer 112b. For example, WAN 102 may include computer systems which are geographically remote and connected to each other through the Internet.

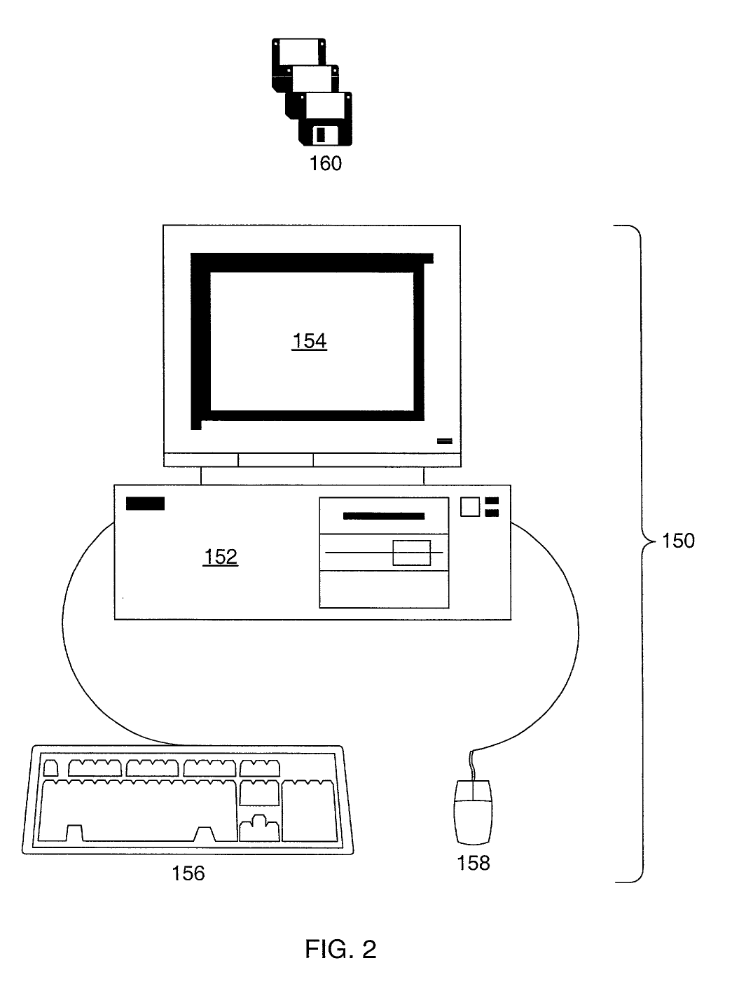

FIG. 2: Typical Computer System

FIG. 2 illustrates a typical computer system 150 which is suitable for implementing various embodiments of a system and a method for implementing a forward conversion strategy. Each computer system 150 typically includes components such as a CPU 152 with an associated memory medium such as floppy disks 160. The memory medium may store program instructions for computer programs, wherein the program instructions are executable by the CPU 152. The computer system 150 may further include a display device such as a monitor 154, an alphanumeric input device such as a keyboard 156, and a directional input device such as a mouse 158. The computer system 150 may be operable to execute the computer programs to implement a forward conversion strategy as described herein.

The computer system 150 preferably includes a memory medium on which computer programs according to various embodiments may be stored. The term “memory medium” is intended to include an installation medium, e.g., a CD-ROM, DVD, or floppy disks 160, a computer system memory such as DRAM, SRAM, EDO RAM, Rambus RAM, etc., or a non-volatile memory such as a magnetic media, e.g., a hard drive, or optical storage. The memory medium may include other types of memory as well, or combinations thereof. In addition, the memory medium may be located in a first computer in which the programs are executed, or may be located in a second different computer which connects to the first computer over a network. In the latter instance, the second computer provides the program instructions to the first computer for execution. Also, the computer system 150 may take various forms, including a personal computer system, mainframe computer system, workstation, network appliance, Internet appliance, personal digital assistant (PDA), television system or other device. In general, the term “computer system” can be broadly defined to encompass any device having a processor which executes instructions from a memory medium. Additionally, a “computer system” may generally describe hardware and software components that in combination may allow execution of computer programs. Computer programs may be implemented in software, hardware, or a combination of software and hardware.

The memory medium preferably stores a software program or programs for implementing a forward conversion strategy as described herein. The software program(s) may be implemented in any of various ways, including procedure-based techniques, component-based techniques, and/or object-oriented techniques, among others. For example, the software program(s) may be implemented using ActiveX controls, C++ objects, JavaBeans, Microsoft Foundation Classes (MFC), browser-based applications (e.g., Java applets), traditional programs, or other technologies or methodologies, as desired. A CPU, such as the host CPU 152, executing code and data from the memory medium includes a means for creating and executing the software program or programs according to the methods and/or block diagrams described below.

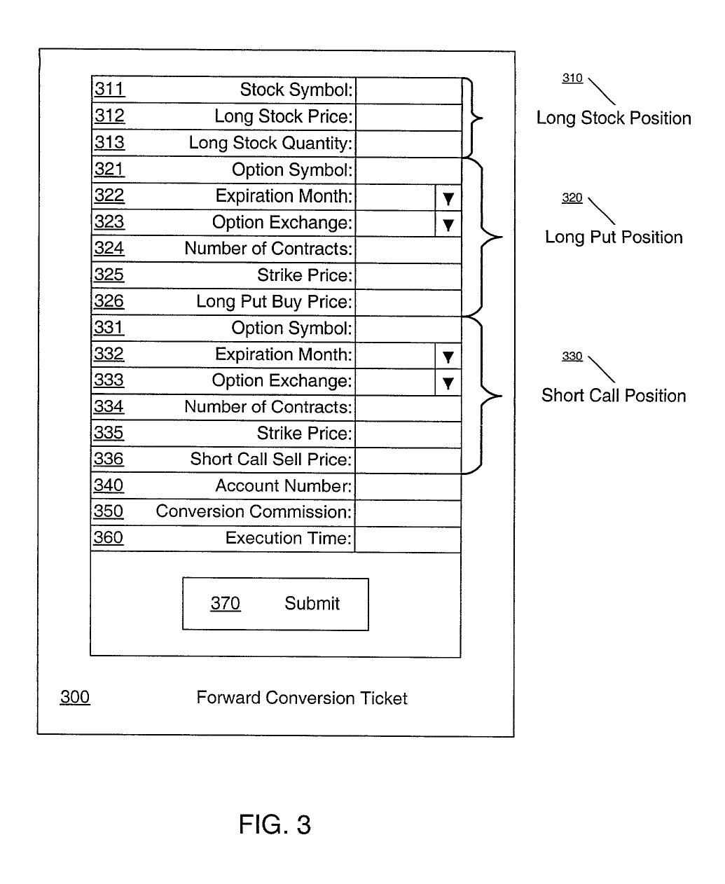

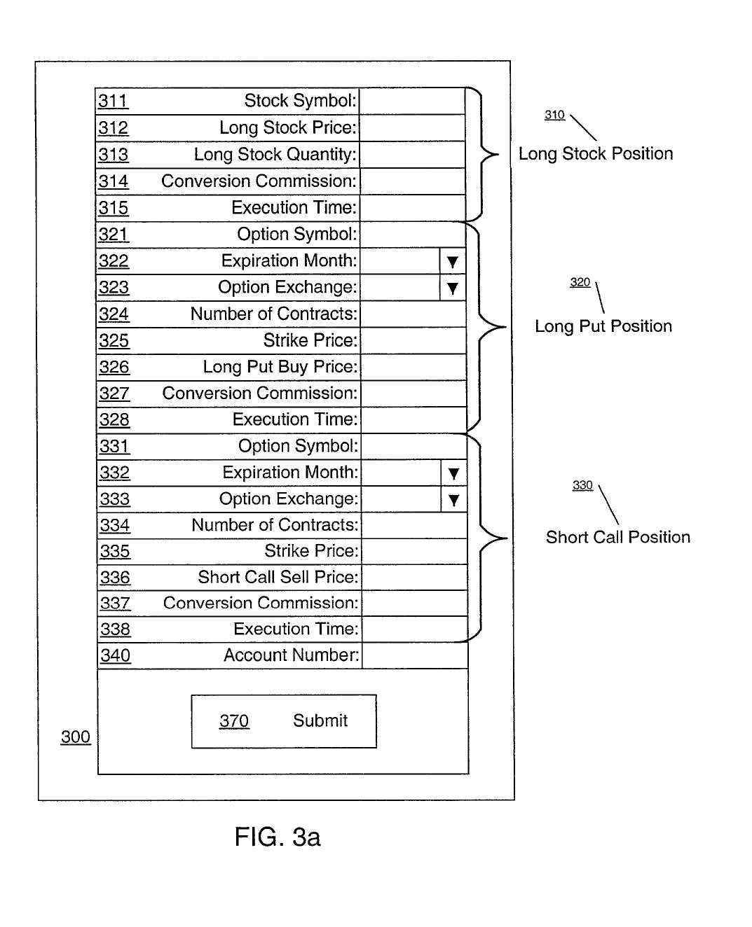

FIG. 3: Forward Conversion Ticket

A “Forward Conversion Ticket” window 300 may appear when a trader selects a “Conversion” option in a graphical user interface, according to one embodiment.

Among the data entry elements that may appear in the “Forward Conversion Ticket” window 300 are the following three groups of elements: a long stock position 310, a long put position 320, and a short call position 330. Additionally, an account number 340 may be pre-filled based on the trader's previous actions within the graphical user interface (e.g., logging in). The pre-filled account number 340 may be edited by the trader. Alternatively, the account number 340 may be a blank field, thus requiring the trader to enter a value.

The last two fields shown in the “Forward Conversion Ticket” window 300 (i.e., Conversion Commission 350 and Execution Time 360) may be read-only fields for the trader. In one embodiment, the Conversion Commission 350 field may display a value when the trader selects a “Compute Commission” option (not shown) on the “Forward Conversion Ticket” window 300. The “Compute Commission” option may be disabled until such time as the trader enters values for the long stock position 310, the long put position 320, and the short call position 330.

In one embodiment, the Conversion Commission 350 may remain blank until such time as the trades are executed. The trader may submit the “Forward Conversion Ticket” information for placement or execution by selecting a “Submit” menu option (not shown), or “Submit” button 370. Upon completion of the execution of the “bundle” of trades representing the conversion, the Execution Time 360 may display a value of the time (e.g., 2:43:57 pm or 14:43:57) at which the trades were executed. The format of the Execution Time 360 may be user configurable.

In one embodiment, the Conversion Commission 350 may be displayed as a single value representing the combined commission for all three parts or legs of the “bundle” of trades representing the conversion. Alternatively, the Conversion Commission 350 field may be replaced with multiple fields 314, 327, and 337 (as shown in FIG. 3a). Multiple Conversion Commission fields 314, 327, and 337 may represent commission values for each of the legs of the “bundle” of trades representing the conversion (e.g., a Long Stock Commission 314, a Long Put Commission 327, and a Short Call Commission 337). The format of Conversion Commission field or fields may be user configurable.

Similarly, the Execution Time 360 may be displayed as a single value representing the time at which all three parts or legs of the “bundle” of trades representing the conversion were executed. Alternatively, the Execution Time 360 field may be replaced with multiple fields 315, 328, and 338. Multiple Execution Time fields 315, 328, and 338 may represent execution times for each of the legs of the “bundle” of trades representing the conversion (e.g., a Long Stock Execution Time 315, a Long Put Execution Time 328, and a Short Call Execution Time 338). The format of the Execution Time field or fields may be user configurable.

The long stock position 310 may include the following entry fields: a stock symbol 311, a long stock price 312, and a long stock quantity 313. As used herein, a “stock symbol” is a series of letters used to identify a stock or a mutual fund. Stock symbols with up to three letters are typically used to identify stocks which are listed and traded on a stock exchange (e.g., the NYSE: New York Stock Exchange). Stock Symbols with four letters are typically used to identify NASDAQ stocks. NASDAQ (National Association of Securities Dealers Automated Quotation System) is a computerized system established by the National Association of Securities Dealers (NASD) to facilitate trading by providing broker/dealers with current bid and ask price quotes on over-the-counter stocks and some exchange listed stocks. Stock Symbols with five letters are typically used to identify NASDAQ stocks other than single issues of common stock. Stock Symbols with five letters ending in X are typically used to identify mutual funds. The term “ticker symbol” is synonymous with the term “stock symbol.”

The long put position 320 may include the following entry fields: a (put) option symbol 321, a (put) expiration month 322, a (put) options exchange 323, a number of (put) contracts 324, a (put) strike price 325, and a long put buy price 326. As used herein, an “option symbol” is a series of letters used to identify an option contract. Stock option contracts generally are for 100 shares of an underlying security (i.e., 10 contracts is equivalent to 1,000 (10*100) shares).

The short call position 330 may include the following entry fields: a (call) option symbol 331, a (call) expiration month 332, a (call) options exchange 333, a number of (call) contracts 334, a (call) strike price 335, and a short call sell price 336. The combination of the long put position 320 and the short call position 330 may be referred to as a “synthetic short sale.” As used herein, a “short sale” exists when a trader borrows a security from a broker and sells the security, with the understanding that the security must later be bought back (hopefully at a lower price) and returned to the broker. As used herein, a “synthetic short sale” is a strategy that accomplishes the same result as a “short sale” through the use of a long put and a short call. For example, consider that a trader buys a long put and sells a short call at the same strike price. At the time of expiration, the price of the underlying security may have one of three relationships with the strike price: (1) the security price is equal to the strike price; (2) the security price is greater than the strike price; or (3) the security price is less than the strike price. In case (1), the put is worthless, and the call is worthless (although either may still be exercised). In case (2), the put is worthless, and the call has some value to the buyer of the option contract. In case (3), the put has some value to the buyer of the option contract, and the call is worthless. In case (2) and case (3), if the trader does not own the underlying security, the trader is effectively short the security.

As shown in FIG. 3, down arrows shown on the right side of the following four entry fields: the (put) expiration month 322, the (put) options exchange 323, the (call) expiration month 332, and the (call) options exchange 333, indicate drop-down lists are available for data entry by the trader. In one embodiment, the (put) expiration month 322 and the (call) expiration month 332 may include the same values in their drop-down lists (e.g., twelve entries representing the months of the year: JAN, FEB, MAR, APR, MAY, JUN, JUL, AUG, SEP, OCT, NOV, and DEC). Similarly, the (put) options exchange 323 and the (call) options exchange 333 may include the same values in their drop-down lists (e.g., “8 Philly” representing the Philadelphia Stock Exchange; the “8” preceding the short version (“Philly”) of the exchange name (“Philadelphia Stock Exchange”) may represent a code number which may be used to represent the “Philly” within computer programs).

The trader may customize the display of the “Forward Conversion Ticket” information in the “Forward Conversion Ticket” window 300. For example, the trader may rearrange the entry fields, as desired. One reason a trader may choose to rearrange the entry fields may be to decrease the time that trader may need to enter values for a forward conversion. Another reason a trader may choose to rearrange the entry fields may be to group decision variables physically near each other (e.g., the long stock price 312, the long put buy price 326, and the short call sell price 336).

In one embodiment, certain entry fields may be automatically populated based on entries made in certain other entry fields, for purposes of speed and accuracy. The trader may choose to disable the automatic population of certain entry fields. Examples of automatic population include the following: (1) upon the trader entering values for the two entry fields: the stock symbol 311 and the (put) options exchange 323, (or, alternatively, the stock symbol 311 and the (call) options exchange 333), the (put) option symbol 321 and the (call) option symbol 331 may be automatically populated; (2) upon the trader entering a value for any one of the three entry fields: the long stock quantity 313, the number of (put) contracts 324 and the number of (call) contracts 334, the other two remaining entry fields may be automatically populated; (3) upon the trader entering a value for the (put) option symbol 321, the (call) option symbol 331 may be automatically populated; (4) upon the trader entering a value for the (put) expiration month 322, the (call) expiration month 332 may be automatically populated; (5) upon the trader entering a value for the (put) options exchange 323, the (call) options exchange 333 may be automatically populated; (6) upon the trader entering a value for the number of (put) contracts 324, the number of (call) contracts 334 may be automatically populated; (7) upon the trader entering a value for the (put) strike price 325, the (call) strike price 335 may be automatically populated. For examples (3) through (7) noted above, the order may be switched (i.e., upon the trader entering a value for the call value, the put value may be automatically populated).

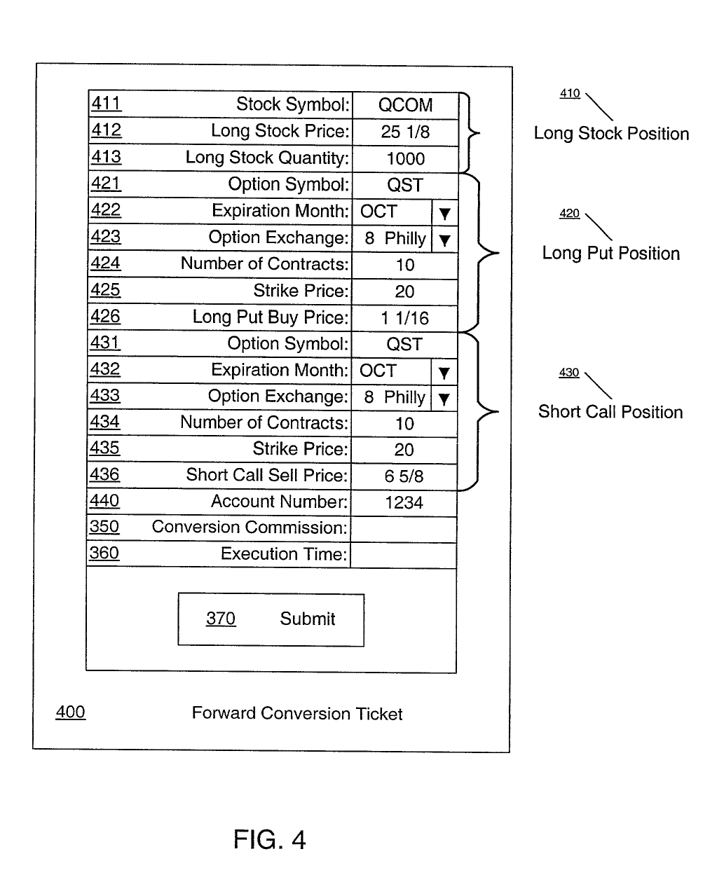

FIG. 4: First Example Using the Forward Conversion Ticket of FIG. 3

A first example of values that may be entered by a trader in a Forward Conversion Ticket 400 are shown in FIG. 4, according to one embodiment. The following three groups of elements: a long stock position 410, a long put position 420, and a short call position 430 are shown in FIG. 4. Below the three groups of elements, an account number 440 fields is shown, containing the value: 1234.

The long stock position 410 may include the following fields, the fields may contain the following values: a stock symbol 411 (value: QCOM), a long stock price 412 (value: 25⅛), and a long stock quantity 413 (value: 1000).

The long put position 420 may include the following fields, the fields may contain the following values: a (put) option symbol 421 (value: QST), a (put) expiration month 422 (value: OCT), a (put) options exchange 423 (value: 8 Philly), a number of (put) contracts 424 (value: 10), a (put) strike price 425 (value: 20), and a long put buy price 426 (value: 1 1/16).

The short call position 430 may include the following fields, the fields may contain the following values: a (call) option symbol 431 (value: QST), a (call) expiration month 432 (value: OCT), a (call) options exchange 433 (value: 8 Philly), a number of (call) contracts 434 (value: 10), a (call) strike price 435 (value: 20), and a short call sell price 436 (value: 6⅝).

The trader may realize a $437.50 gain on this forward conversion strategy example. The amount of the gain may be computed in the following manner: (1) subtracting the cost of the purchase of the long stock position 410 (i.e., 1000 shares of QCOM at 25⅛ per share; 1000*25⅛): −$25,125.00; (2) subtracting the cost of the purchase of the long put position 420 (i.e., 10 put contracts (10 contracts*100 shares per contract=1000 shares) for put option QST on the Philly exchange at 1 1/16 per share, strike price of 20, expiring in October; 1000*1 1/16): −$1,062.50; (3) adding the proceeds of the sale of the short call position 430 (i.e., 10 call contracts (10 contracts*100 shares per contract=1000 shares) for call option QST on the Philly exchange at 6⅝ per share, strike price of 20, expiring in October; 1000*6⅝): +$6,625.00; and (4) adding the proceeds of selling the long stock position (i.e., 1000*20): +$20,000.00. Combining the summing the costs and proceeds results in a net gain, as follows:

(i.e., −$25,125.00−$1,062.50+$6,625.00+$20,000.00=+$437.50).

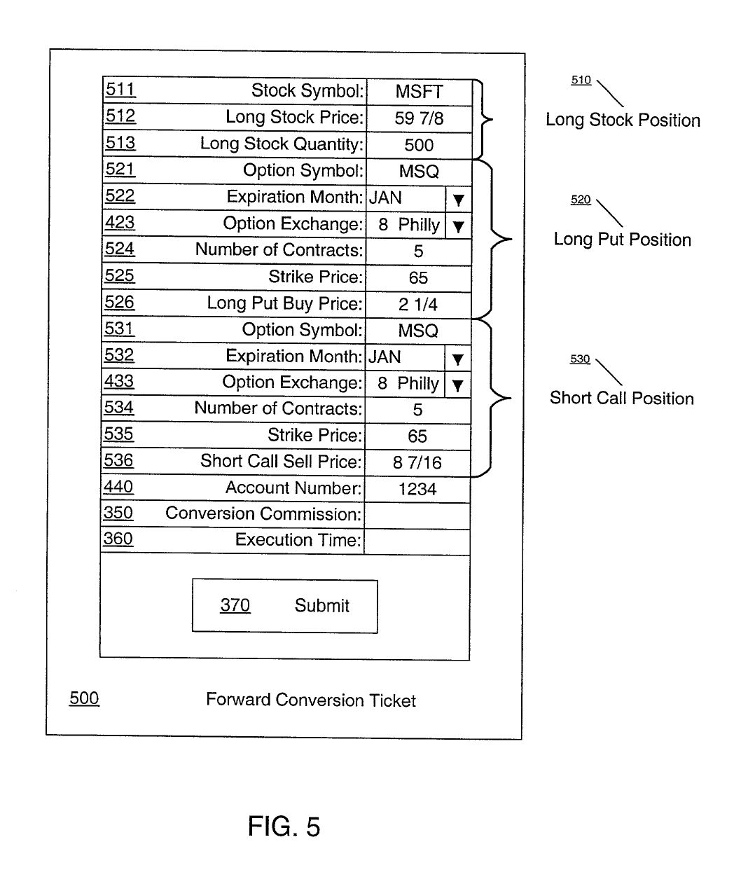

FIG. 5: Second Example Using the Forward Conversion Ticket of FIG. 3

A second example of values that may be entered by a trader in a Forward Conversion Ticket 500 are shown in FIG. 5, according to one embodiment. The following three groups of elements: a long stock position 510, a long put position 520, and a short call position 530 are shown in FIG. 5. Below the three groups of elements, an account number 440 fields is shown, containing the value: 1234.

The long stock position 510 may include the following fields, the fields may contain the following values: a stock symbol 511 (value: MSFT), a long stock price 512 (value: 59⅞), and a long stock quantity 513 (value: 500).

The long put position 520 may include the following fields, the fields may contain the following values: a (put) option symbol 521 (value: MSQ), a (put) expiration month 522 (value: JAN), a (put) options exchange 423 (value: 8 Philly), a number of (put) contracts 524 (value: 5), a (put) strike price 525 (value: 65), and a long put buy price 526 (value: 2¼).

The short call position 530 may include the following fields, the fields may contain the following values: a (call) option symbol 531 (value: MSQ), a (call) expiration month 532 (value: JAN), a (call) options exchange 433 (value: 8 Philly), a number of (call) contracts 534 (value: 5), a (call) strike price 535 (value: 65), and a short call sell price 536 (value: 8 7/16).

The trader may realize a $5,656.25 gain on this forward conversion strategy example. The amount of the gain may be computed in the following manner: (1) subtracting the cost of the purchase of the long stock position 510 (i.e., 500 shares of MSFT at 59⅞ per share; 500*59⅞): −$29,937.50; (2) subtracting the cost of the purchase of the long put position 520 (i.e., 5 put contracts (5 contracts*100 shares per contract=500 shares) for put option MSQ on the Philly exchange at 2¼ per share, strike price of 65, expiring in January; 500*2¼): −$1,125.00; (3) adding the proceeds of the sale of the short call position 530 (i.e., 5 call contracts (5 contracts*100 shares per contract=500 shares) for call option MSQ on the Philly exchange at 8 7/16 per share, strike price of 65, expiring in January; 500*8 7/16): +$4,218.75; and (4) adding the proceeds of selling the long stock position (i.e., 500*65): +$32,500.00. Summing the proceeds and costs results in a net gain, as follows:

(i.e., −$29,937.50−$1,125.00+$4,218.75+$32,500.00=+$5,656.25).

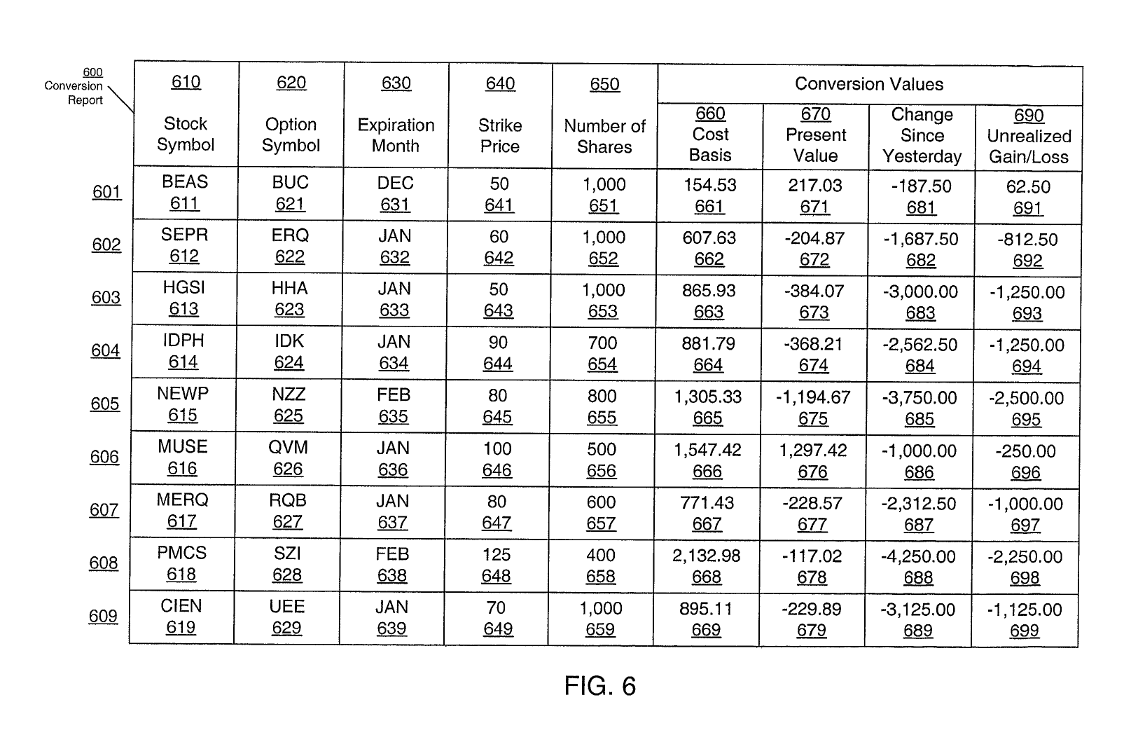

FIG. 6: Conversion Report

A “Conversion Report” 600 may appear when a trader selects a “Conversion Report” option in a graphical user interface, according to one embodiment.

Among the columns that may appear in the “Conversion Report” 600 are the following: stock symbol 610, option symbol 620, expiration month 630, strike price 640, number of shares 650, conversion cost basis 660, conversion present value 670, change in the conversion present value since the previous trading session (i.e., yesterday) 680, and unrealized gain/loss on the conversion 690.

In one embodiment, a trader may configure the Conversion Report to display certain columns and not other columns. Additionally, the trader may arrange the order of the columns. Conversion Report columns not shown in FIG. 6 that may be available for a trader to choose from when configuring a Conversion Report may include conversion details (e.g., long stock price, options exchange, long put buy price, short call sell price, conversion commission, conversion execution time), among others.

In one embodiment, the trader may sort a conversion report by any particular column. A trader may implement such a sort by selecting the title of the column (e.g., unrealized gain/loss on the conversion 690) via a menu item or a click on a directional input device (e.g., mouse 158 of FIG. 2). For example, a single click of the directional input device on a title of a column may implement sorting of the rows of the conversion report by the selected column in ascending order, whereas a double click of the directional input device on a title of a column may implement sorting of the rows of the conversion report by the selected column in descending order, or vice versa. The action (i.e., sorting in ascending or descending order) associated with the selection of the trader (i.e., a single click or a double click) may be user-configurable (i.e., the trader may specify that a single click is to represent sorting in descending order and a double click is to represent sorting in ascending order). Similarly, various menu items may implement sorting in ascending or descending order.

“Conversion Report” 600 may include nine rows of data illustrating example forward conversion securities strategies, the nine rows are labeled 601 through 609. As shown in FIG. 6, each element of strategy row 601, for example, has a corresponding right-most digit of “1” (i.e., 611, 621, 631, 641, 651, 661, 671, 681, and 691). Correspondingly, each element of the remaining strategy rows (602 through 609) exhibit the same characteristic regarding their right-most digits as strategy row 601 (i.e., strategy row 602 includes elements 612, 622, 632, 642, 652, 662, 672, 682, and 692; strategy row 603 includes elements 613, 623, 633, 643, 653, 663, 673, 683, and 693; and so on). Similarly, each element of column stock symbol 610, for example, has as the two left-most digits the value “61” (i.e., 611, 612, 613, 614, 615, 616, 617, 618, and 619). Correspondingly, each element of the remaining columns (620 through 690) exhibit the same characteristic regarding their two left-most digits as column stock symbol 610 (i.e., column option symbol 620 includes elements 621, 622, 623, 624, 625, 626, 627, 628, and 629; column expiration month 630 includes elements 631, 632, 633, 634, 635, 636, 637, 638, and 639; and so on).

The values in the last four columns illustrated in FIG. 6 (i.e., conversion cost basis 660, conversion present value 670, change in the conversion present value since the previous trading session (i.e., yesterday) 680, and unrealized gain/loss on the conversion 690) represent calculations. The conversion cost basis 660 column may represent costs and proceeds related to the three underlying transactions that form the conversion as described in above embodiments. Costs may include commissions and any other expenses incurred in making the underlying transactions.

The conversion present value 670 column may represent a summation of daily “mark-to-market” prices for each of the three positions: the long stock position, the long put position, and the short call position, as described in above embodiments. As used herein, “mark-to-market” is the process of recording the price or value of a security on a periodic basis (e.g., daily), to calculate profits and losses. In one embodiment, if any one of the three positions is missing from the account at the time the conversion present value 670 column is computed, that condition may be flagged, and the trader may be notified. In addition to notification, the trader or user may configure the system to automatically re-establish any missing positions, to maintain the integrity of the conversion strategy.

The change in the conversion present value since the previous trading session (i.e., yesterday) 680 column may represent the difference between the conversion present value 670 of two consecutive trading sessions. If the conversion present value of the earlier of the two consecutive trading sessions is larger than the conversion present value of the later of the two consecutive trading sessions, then the change in the conversion present value 680 will be a negative number. Conversely, if the conversion present value of the earlier of the two consecutive trading sessions is smaller than the conversion present value of the later of the two consecutive trading sessions, then the change in the conversion present value 680 will be a positive number. In one embodiment, the conversion present value 670 may be computed using closing prices of a trading session.

The unrealized gain/loss on the conversion 690 column may represent the conversion cost basis 660 subtracted from the conversion present value 670. If the conversion present value 670 is larger than the conversion cost basis 660, then the unrealized gain/loss on the conversion 690 will be a positive number. Conversely, if the conversion present value 670 is smaller than the conversion cost basis 660, then the unrealized gain/loss on the conversion 690 will be a negative number. Alternative methods of computing the unrealized gain/loss on the conversion 690 column may be implemented.

Referring to strategy row 604 of FIG. 6, the conversion cost basis 660 column element, the conversion present value 670 column element, and the unrealized gain/loss on the conversion 690 column element are shown as: 881.79, −368.21, and −1,250.00, respectively. It may be shown that subtracting the conversion cost basis 660 column element from the conversion present value 670 column element results in the value shown in the unrealized gain/loss on the conversion 690 column element:

(i.e., −$368.21−$881.79=−$1,250.00).

The same calculation (i.e., subtracting the conversion cost basis 660 column element from the conversion present value 670 column element) for each of the other strategy rows 601, 602, 603, 605, 606, 607, 608, and 609 may result in the corresponding value shown in the unrealized gain/loss on the conversion 690 column element of each strategy row, respectively.

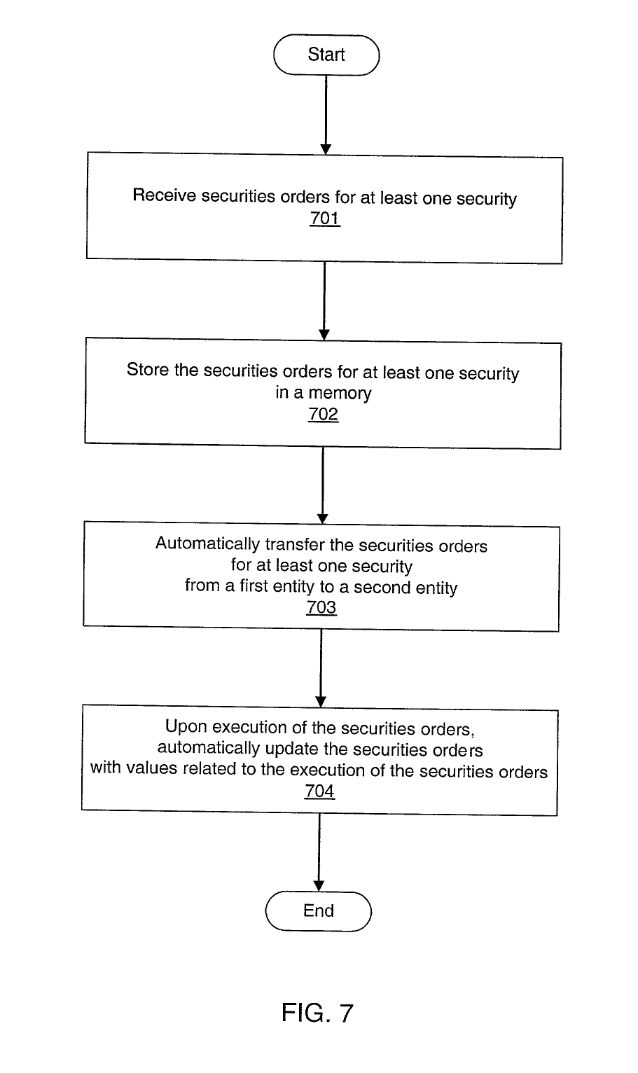

FIG. 7: Collecting Information Necessary for Implementing a Forward Conversion

FIG. 7 is a flowchart illustrating a method for collecting information necessary to implement a forward conversion strategy in real-time, according to one embodiment.

In step 701, securities orders may be received into a first computer system. The securities orders may include a long stock order, a long put order, and a short call order, for at least one security. The long stock order may be synonymous with the long stock position 310 as illustrated in FIG. 3. Similarly, the long put order may be synonymous with the long put position 320 as illustrated in FIG. 3, and the short call order may be synonymous with the short call position 330 as illustrated in FIG. 3.

In step 702, the received securities orders may be stored in a memory coupled to the first computer system. Alternatively, the received securities orders may be stored in a memory coupled to a second computer system where the second computer system may be coupled to the first computer system over a computer network.

In step 703, the securities orders may be automatically transferred from a first entity to a second entity. One purpose of the transfer may be for subsequent execution of the securities orders. In one embodiment, the securities orders may be automatically transferred in real-time. Alternatively, the securities orders may be automatically transferred within thirty minutes of receiving the securities orders. The orders may be received and transferred electronically. As used herein, receiving and/or transferring an order “electronically,” may refer to receiving or transferring information from a first computer to a second computer via a network, or from a user interface device to a computer. Receiving and/or transferring an order electronically may include receiving and/or transferring an order via a user interface device which includes a voice recognition system. However, generally receiving and/or transferring an order electronically may exclude person to person verbal communication as a necessary step in receiving and/or transferring orders..

In step 704, subsequent to execution of the securities orders, the securities orders may be automatically updated with values related to the execution of the securities orders (e.g., a conversion commission, an execution time).

In certain embodiments, in any of steps 701, 702, 703, or 704 the method may include verifying or checking at least portions of the received securities orders for potential errors. For example, the first computer, or the second computer may verify that an option symbol in an order corresponds to an option for the security identified in the long stock order. Another example may include verifying that a number of option contracts in one or more options orders corresponds to a number of shares in a long stock order.

Various embodiments further include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, conveyed via a communication medium such as networks 102 and/or 104 (as shown in FIG. 1) and/or a wireless link.

Although the system and method of the present invention have been described in connection with several embodiments, the invention is not intended to be limited to the specific forms set forth herein, but on the contrary, it is intended to cover such alternatives, modifications, and equivalents as can be reasonably included within the spirit and scope of the invention as defined by the appended claims.

It will be appreciated by those skilled in the art having the benefit of this disclosure that this invention is believed to provide methods and systems for implementing a forward conversion strategy. Further modifications and alternative embodiments of various aspects of the invention will be apparent to those skilled in the art in view of this description. It is intended that the following claims be interpreted to embrace all such modifications and changes and, accordingly, the specification and drawings are to be regarded in an illustrative rather than a restrictive sense.

What is claimed:

1. A computer-implemented method for implementing a forward conversion strategy, the method comprising:
receiving securities orders for at least one security, wherein the securities orders comprise a long stock order, a long put order, and a short call order; and
automatically transferring the received securities orders from a first entity to a second entity for execution of the securities orders.

2. The method of claim 1, wherein the securities orders are received electronically from a single computer driven input screen.

3. The method of claim 1, wherein the automatic transferring of the received securities orders occurs in real-time.

4. The method of claim 1, wherein the automatic transferring of the received securities orders occurs within thirty minutes of receiving the securities orders.

5. The method of claim 1, wherein the securities orders are received in a computer system, the method further comprising:
storing the securities orders in a memory coupled to the computer system.

6. The method of claim 1, further comprising:
storing the securities orders in a memory coupled to the first computer system or in a memory coupled to a second computer system, and wherein the second computer system is coupled to the first computer system over a computer network.

7. The method of claim 6, wherein the computer network comprises the Internet.

8. The method of claim 1, further comprising:
automatically updating the securities orders upon execution of the securities orders.

9. The method of claim 8, further comprising automatically displaying the updated securities orders on a computer system.

10. The method of claim 8, wherein the second entity automatically updates the securities orders.

11. The method of claim 8, further comprising transmitting the updated securities orders to one or more post-execution entities.

12. The method of claim 11, wherein the one or more post-execution entities comprise a clearing firm.

13. The method of claim 1, wherein automatically transferring the received securities orders further comprises:
automatically transferring the received securities orders from the first entity to one or more intermediate entities; and
automatically transferring the received securities orders from the one or more intermediate entities to the second entity for execution of the securities orders.

14. The method of claim 13, wherein the one or more intermediate entities comprise a broker.

15. The method of claim 1, wherein the first entity comprises a trader.

16. The method of claim 1, wherein the second entity comprises a dealer on a floor of an exchange.

17. The method of claim 16, wherein the exchange comprises a stock exchange.

18. The method of claim 16, wherein the exchange comprises an options exchange.

19. The method of claim 1, wherein the long stock order comprises a long stock symbol, and a long stock quantity.

20. The method of claim 1, wherein the long stock order comprises a long stock price.

21. The method of claim 1, wherein the long put order comprises an option symbol, an expiration month, a strike price, and a number of contracts.

22. The method of claim 1, wherein the long put order comprises an options exchange.

23. The method of claim 1, wherein the long put order comprises a long put buy price.

24. The method of claim 1, wherein the short call order comprises an option symbol, an expiration month, a strike price, and a number of contracts.

25. The method of claim 1, wherein the short call order comprises an options exchange.

26. The method of claim 1, wherein the short call order comprises a short call sell price.

27. The method of claim 1, wherein the orders are received and transferred electronically.

28. The method of claim 1, further comprising verifying at least one portion of the securities orders.

29. A computer system configured to carry out the method of claim 1.

30. A carrier medium comprising program instructions executable to implement the method of claim 1.

31. A computer-implemented method for implementing a forward conversion strategy, the method comprising:
receiving securities orders for at least one security, wherein the securities orders comprise a long stock order, a long put order, and a short call order;
storing the securities orders in a memory coupled to a first computer system or in a memory coupled to a second computer system wherein the second computer system is coupled to the first computer system over a computer network;
automatically transferring the received securities orders from a first entity to a second entity for execution of the securities orders; and
automatically updating the securities orders subsequent to execution of the securities orders, wherein the updating comprises storing a conversion commission for the executed securities orders.

32. The method of claim 31, wherein the securities orders are received electronically from a single computer driven input screen.

33. The method of claim 31, wherein automatically transferring the received securities orders occurs in real-time.

34. The method of claim 31, wherein automatically transferring the received securities orders occurs within thirty minutes of receiving the securities orders.

35. The method of claim 31, wherein automatically updating the securities orders occurs in real-time.

36. The method of claim 31, wherein automatically updating the securities orders occurs within thirty minutes of execution of the securities orders.

37. The method of claim 31, wherein the computer network comprises the Internet.

38. The method of claim 31, wherein the updating further comprises storing an execution time for the executed securities orders.

39. The method of claim 31, further comprising automatically displaying the updated securities orders on the first computer system.

40. The method of claim 31, wherein the second entity automatically updates the securities orders.

41. The method of claim 31, further comprising transmitting the updated securities orders to one or more post-execution entities.

42. The method of claim 41, wherein the one or more post-execution entities comprise a clearing firm.

43. The method of claim 31, wherein automatically transferring the received securities orders further comprises:
automatically transferring the received securities orders from the first entity to one or more intermediate entities; and
automatically transferring the received securities orders from the one or more intermediate entities to the second entity for execution of the securities orders.

44. The method of claim 43, wherein the one or more intermediate entities comprises a broker.

45. The method of claim 31, wherein the first entity comprises a trader.

46. The method of claim 31, wherein the second entity comprises a dealer on a floor of an exchange.

47. The method of claim 46, wherein the exchange comprises a stock exchange.

48. The method of claim 46, wherein the exchange comprises an options exchange.

49. The method of claim 31, wherein the long stock order comprises a long stock symbol, and a long stock quantity.

50. The method of claim 31, wherein the long stock order comprises a long stock price.

51. The method of claim 31, wherein the long put order comprises an option symbol, an expiration month, a strike price, and a number of contracts.

52. The method of claim 31, wherein the long put order comprises an options exchange.

53. The method of claim 31, wherein the long put order comprises a long put buy price.

54. The method of claim 31, wherein the short call order comprises an option symbol, an expiration month, a strike price, and a number of contracts.

55. The method of claim 31, wherein the short call order comprises an options exchange.

56. The method of claim 31, wherein the short call order comprises a short call sell price.

57. The method of claim 31, wherein the orders are received and transferred entirely electronically, with no verbal communication.

58. The method of claim 31, further comprising verifying at least one portion of the securities orders.

59. A computer system configured to carry out the method of claim 31.

60. A carrier medium comprising program instructions executable to implement the method of claim 31.

61. A system configured to implement a forward conversion strategy comprising:
a first computer system coupled to a network, the first computer system comprising (a) a memory configured to receive security orders from a user interface, and (b) a display system configured to display the received securities orders in a securities display format, wherein the securities orders affect the securities display format;
wherein the first computer system is configured to automatically transfer the received securities orders for subsequent execution of the securities orders; and
wherein the first computer system or a second computing system is further configured to receive execution completion information from the network and to display the execution completion information in the securities display format.

62. The system of claim 61, wherein the first computer system is further configured to automatically transfer the received securities orders in real-time.

63. The system of claim 61, wherein the first computer system is further configured to automatically transfer the received securities orders within thirty minutes of receiving the securities orders.

64. The system of claim 61, wherein the first computer system is further configured to automatically update the securities display format with execution completion information in real-time.

65. The system of claim 61, wherein the first computer system is further configured to automatically update the securities display format with execution completion information within thirty minutes of the execution of securities orders.

66. The system of claim 61, wherein the security orders for at least one security comprise a long stock order, a long put order, and a short call order.

67. The system of claim 61, wherein the execution completion information comprises a conversion commission for the securities orders.

68. The system of claim 61, wherein the execution completion information comprises an execution time for the securities orders.

69. A carrier medium comprising program instructions, wherein the program instructions are executable to implement:
collecting security order data from a user interface for at least one security, wherein the security order data comprises a long stock order, a long put order, and a short call order; and
automatically transmitting the security order data from a first entity to a second entity for execution of the securities orders.

70. The carrier medium of claim 69, wherein the securities orders are automatically transmitted in real-time.

71. The carrier medium of claim 69, wherein the securities orders are automatically transmitted within thirty minutes of being entered.
